(19) United States
(12) Patent Application Publication
(10) Pub. No.: US 2026/0062185 A1
(43) Pub. Date: Mar. 5, 2026

(54) Multi-Compartment Food And Beverage Container Assembly

(71) Applicant: Ryan Mundy, Riverside, RI (US)

(72) Inventor: Ryan Mundy, Riverside, RI (US)

(21) Appl. No.: 19/318,155

(22) Filed: Sep. 3, 2025

Related U.S. Application Data
(60) Provisional application No. 63/689,919, filed on Sep. 3, 2024.

(51) Int. Cl. B65D 51/28; B65D 43/02; B65D 85/72

(52) U.S. Cl. CPC B65D 51/28; B65D 43/0229; B65D 43/0231; B65D 85/72

(57) ABSTRACT

A multi-compartment food and beverage container assembly is provided. The container assembly comprises a main body container, inner container, and cover. The different container pieces can be easily fastened to each other. The main body container and inner container can be filled with various food and beverage items. The container pieces store the food and beverage items to keep the items fresh. For example, the main container may contain a beverage such as water, energy drink, juice, milk, and the like, The inner container may store a food item such as trail mix, fruit, granola, and the like. The main container and inner container can be easily detached from each other. Once the container pieces are detached, the food and beverage items can be mixed together.

### CROSS-REFERENCE TO RELATED APPLICATIONS

The application claims the benefit of U.S. Provisional Ser. No. 63/689,919 filed Sep. 3, 2024, the entire disclosure of which is hereby incorporated by reference.

### BACKGROUND OF THE INVENTION

### Field of the Invention

The present invention generally relates to a multi-compartment food and beverage container assembly, wherein the compartments can be easily attached together and detached as desired.

### Brief Review of the Related Art

In recent years, food containers containing multiple connected compartments for storing food items have become popular. For example, the food container can have a first compartment for storing a main meal item or snack such as meat, fish, pasta, salad, vegetables, fruit, chips, cookies, and the like. The food container also can have a second compartment that can be used for storing minor food items such as condiments, salad dressings, dips, sauces, and the like. The compartments keep the food components separate. In practice, the user can decide if he/she wants to mix the minor food item from the second compartment with the major food item from the first compartment. If the user decides to mix the food items, he/she can decide when and how much mixing should be done.

However, many conventional food containers have complex designs, and the compartments are connected via multiple pieces. Such containers are cumbersome and difficult to carry and use. Many containers are not easy to take apart for accessing and consuming the food items. In addition, many food containers are often ineffective for storing beverages. The beverage compartment might not be adequately sized. Also, a user might find it difficult to access the compartment containing the beverage. The user might not be able to easily bring the beverage compartment to their mouth for drinking the beverage.

Thus, there is a need for a new multi-compartment food and beverage container that is easy to carry and use. The container should be able to effectively store both food and beverage items. These containers and the different compartments should be easy to assemble and disassemble. The present invention provides such a multi-compartment food and beverage container. Other features, benefits, and advantages of the present invention are described further below.

### SUMMARY OF THE INVENTION

The present invention provides a multi-compartment food and beverage container assembly. The container assembly comprises a main body container, inner container, and cover. The different container pieces can be easily fastened to each other. The main body container and inner container can be filled with various food and beverage items. The different container pieces store the food and beverage items to keep the items fresh.

More particularly, the present invention relates to a multi-compartment container assembly for food and beverage items, the assembly comprising: a) a main container having an outer perimeter wall; an upper end portion; and a bottom base, wherein the upper end portion and bottom base are joined to the outer perimeter wall to define a first interior compartment, and the upper end portion has internal threads; b) an inner container removably fastened to the main container, the inner container having an outer perimeter wall; an upper end portion; and a bottom base, wherein the upper end portion and bottom base are joined to the outer perimeter wall to define a second interior compartment; the outer perimeter wall having a top section and lower section with a projecting collar disposed between the top and bottom sections; the top and bottom sections having external threads, the external threads of the bottom section engaging the internal threads of the main container; and c) a cover removably fastened to the inner container; the cover having an internal cavity with upper and lower end portions, the lower end portion having internal threads, wherein the internal threads engage the external threads of the top section of the inner container.

The upper end portion of the main container and inner container preferably have peripheral rims. In one embodiment, the cover comprises an upper handle having an inverted U-shaped structure. The main container typically has a cylindrical shape and can be made of any suitable material such as metal or plastics.

In another embodiment, the inner container is removably fastened to the main container. The inner container has an outer perimeter wall; an upper end portion; and a bottom base, wherein the upper end portion and bottom base are joined to the outer perimeter wall to define a second interior compartment. The outer perimeter wall has a top section and lower section with a projecting collar disposed between the top and bottom sections. The top section has a slotted channel, and the bottom section has external threads, the external threads of the bottom section engaging the internal threads of the main container. The cover is removably fastened to the inner container; wherein the cover has an internal cavity with upper and lower end portions. The lower end portion has a locking pin that engages a slotted channel in the top section of the inner container.

The top section of the inner container preferably contains a horizontally-extending channel and vertically-extending channel. The horizontally-extending vertically-extending channels can be joined to form an inverted T-shaped channel structure.

### BRIEF DESCRIPTION OF THE DRAWINGS

The novel features that are characteristic of the present invention are set forth in the appended claims. However, the preferred embodiments of the invention, together with further objects and attendant advantages, are best understood by reference to the following detailed description in connection with the accompanying drawings in which:

FIG. 1 is a perspective view of one embodiment of the multi-compartment container assembly of the present invention;

FIG. 2 is a close-up perspective view of the main body container of the multi-compartment container assembly shown in FIG. 1;

FIG. 3 is an exploded view of the multi-compartment container assembly shown in FIG. 1, wherein the cover, inner container, and main body container are shown in detail;

FIG. 4 is a close-up exploded view of the cover and inner container of the multi-compartment container assembly shown in FIG. 3;

FIG. 5 is a perspective view of the cover and inner container shown in FIG. 4, wherein the cover and inner container have been fastened together;

FIG. 6 is a perspective view of another embodiment of the multi-compartment container assembly of the present invention;

FIG. 7 is a close-up perspective view of the main body container of the multi-compartment container assembly shown in FIG. 6;

FIG. 8 is an exploded view of the multi-compartment container assembly shown in FIG. 6, wherein the cover, inner container, and main body container are shown in detail;

FIG. 9 is a close-up perspective view of the cover and inner container of the multi-compartment container assembly shown in FIG. 8, wherein the cover has been unfastened from the inner container; and

FIG. 10 is a close-up perspective view of the cover and inner container of the multi-compartment container assembly shown in FIG. 9, wherein the cover has been fastened to the inner container.

### DETAILED DESCRIPTION OF THE INVENTION

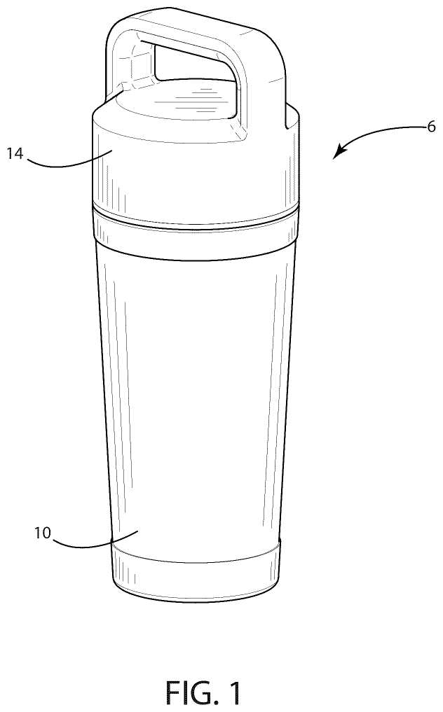

Referring to the Figures, where like reference numerals are used to designate like elements, and particularly FIG. 1, one embodiment of the multi-compartment container assembly of the present invention is shown. The container assembly, generally indicated at (6), comprises a main body container (10). The main container (10) can have any suitable structure; for example, it can have a cylindrical shape as shown in FIG. 1. The main container (10) can be made from metal, plastic, or other suitable material. An inner container (12), which is not shown in FIG. 1, is coupled to the main body container (10) as described further below. The multi-compartment container assembly (6) further includes a cover or lid (14) as shown in FIG. 1.

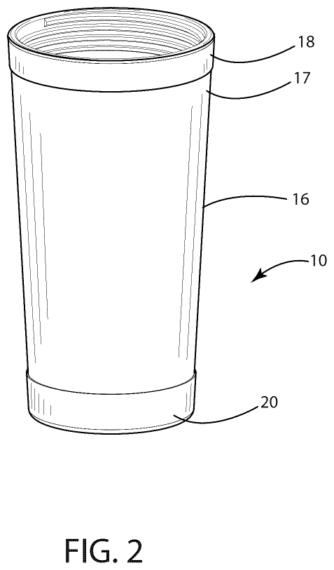

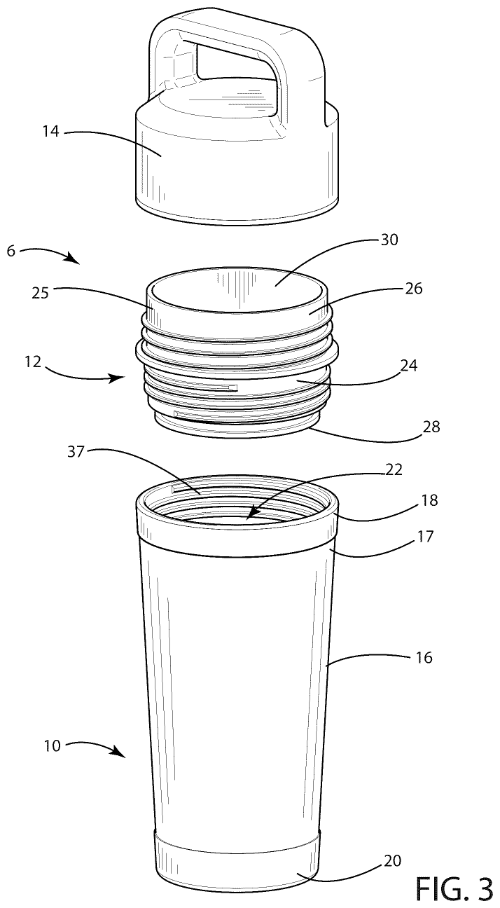

More particularly, in one preferred embodiment as shown in FIG. 2, the main container (10) includes an outer perimeter wall (16); an upper end portion (17) having a peripheral rim (18); and a bottom base (20). Referring to FIG. 3, the upper end portion (17) of the main container (10) further includes internal threads (37). The upper end portion (17) and base (20) are joined to the outer perimeter wall (16) to define an interior compartment or chamber (22) for holding a beverage or food item as described further below.

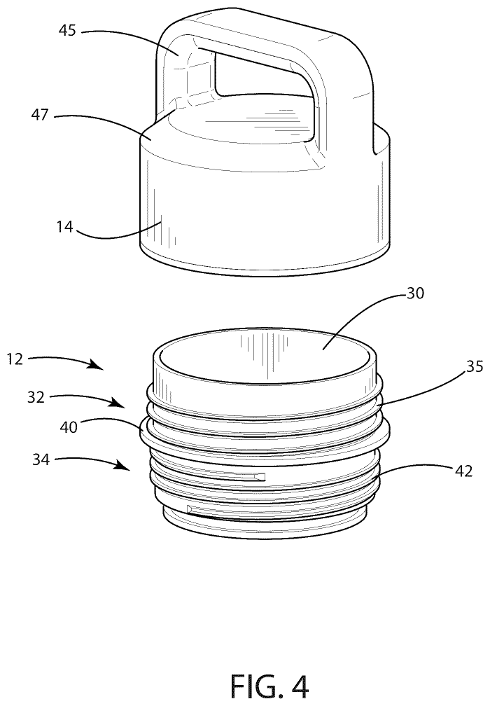

Turning to FIG. 4, the inner container (12) is shown. The inner container (12) can have any suitable structure; for example, it can have a cylindrical shape as shown in FIG. 4. The inner container (12) can be made from metal, plastic, or other suitable material. The inner container (12) includes an outer perimeter wall (24); an upper end portion (25) having a peripheral rim (26); and a bottom base (28). The upper end portion (25) and base (28) are joined to the outer perimeter wall (24) to define an interior compartment or chamber (30) for holding a beverage or food item as described further below.

The inner container (12) is removably coupled to the main container (10). As shown in FIG. 4, in the inner container (12), the outer perimeter wall (24) has a top section (32) and lower section (34). A projecting collar (40) is disposed between the top and bottom sections (32, 34). The top section (32) has an outer periphery that is threaded (35). These external threads (35) are complementary to the internal threads (not shown) of the cover (14). The external threads (35) of the top section (32) engage the internal threads of the cover (14) when the cover is fastened to the inner container (12) as described further below. The bottom section (34) of the inner container (12) also has an outer periphery that is threaded (42). These external threads (42) are complementary to the internal threads (37) of the main container (10). The external threads (42) of the bottom section (34) engage the internal threads (37) of the main container (10) when the inner container (12) is fastened to the main container (10). The intermediate projecting collar (40) is positioned between the top and bottom sections (32, 34).

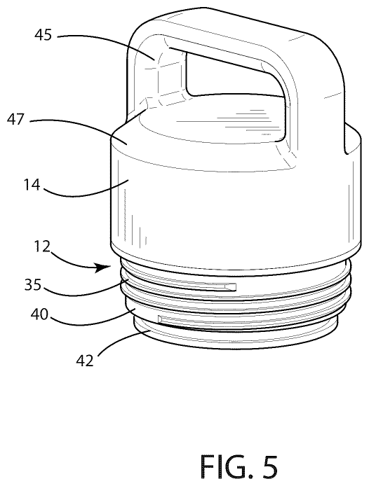

As discussed above, the external threads (35) of the top section (32) of the inner container (12) are complementary to the internal threads of the cover (14). Turning to FIG. 5, when the cover (14) is placed on and screwed onto the inner container (12), the external threads (35) of the top section (32) of the inner container (12) engage the internal threads of the cover (14); and the multi-compartment container assembly (6) is sealed. With the cover (14) thus fastened to the inner container (12), any food and beverage items stored within the inner container (12) are prevented from spilling out. The cover (14) preferably includes an upper handle (45) having an inverted U-shape. The user can easily grasp the handle (45) with their left or right hand and hold the multi-compartment container assembly (6). The upper handle (45) is ergonomically designed so the user can comfortably and efficiently insert their fingers through the opening, while placing their thumb on the top surface of (47) to hold the multi-compartment container assembly (6) securely.

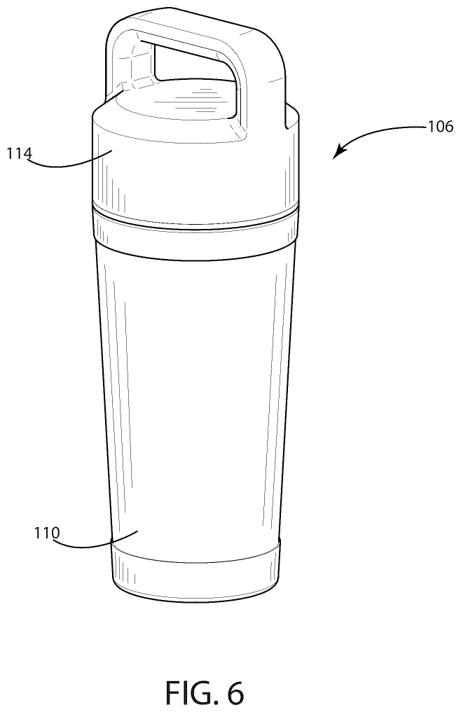

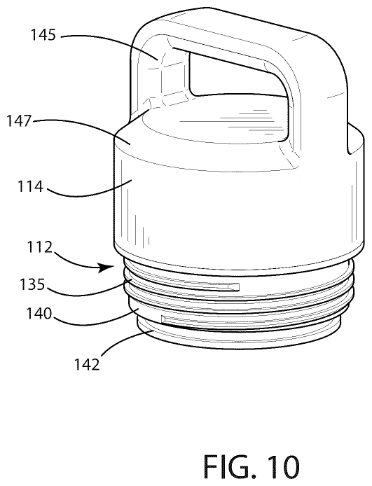

Turning to FIGS. 6-10, another embodiment of the multi-compartment container assembly of the present invention is shown. The container assembly, generally indicated at (106), comprises a main body container (110). The main container (110) can have any suitable structure; for example, it can have a cylindrical shape as shown in FIG. 6. The main container (110) can be made from metal, plastic, or other suitable material. An inner container (112), which is not shown in FIG. 6, is coupled to the main body container (110) as described further below. The multi-compartment container assembly (106) further includes a cover or lid (114) as shown in FIG. 6.

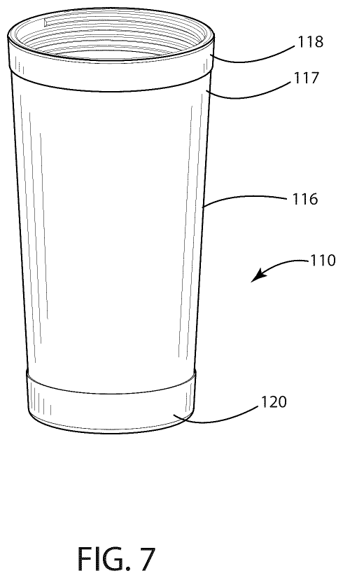

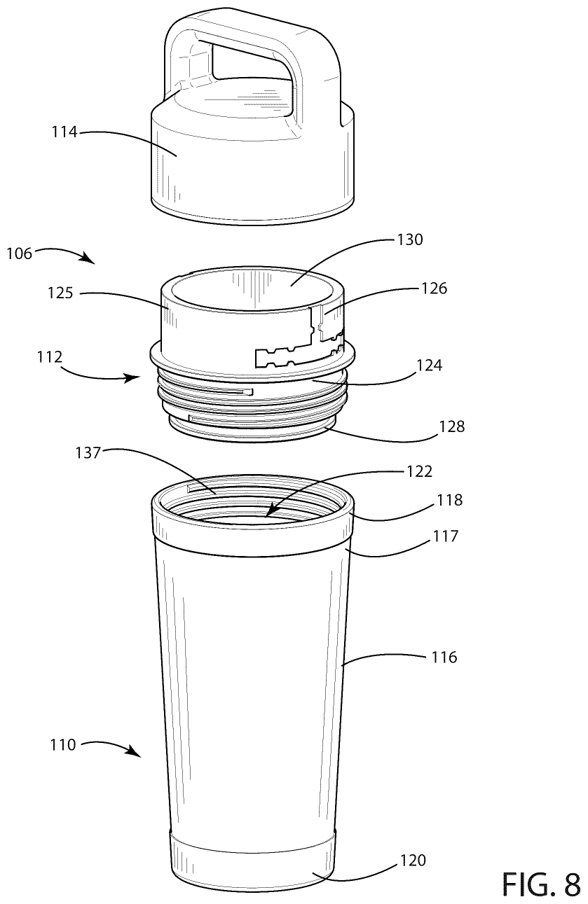

As shown in FIG. 7, the main container (110) includes an outer perimeter wall (116); an upper end portion (117) having a peripheral rim (118); and a bottom base (120). Referring to FIG. 8, the upper end portion (117) of the main container (110) further includes internal threads (137). The upper end portion (117) and base (120) are joined to the outer perimeter wall (116) to define an interior compartment or chamber (122) for holding a beverage or food item as described further below.

As shown in FIG. 8, the inner container (112) can have any suitable structure and preferably has a cylindrical shape. The inner container (112) can be made from metal, plastic, or other suitable material. The inner container (112) includes an outer perimeter wall (124); an upper end portion (125) having a peripheral rim (126); and a bottom base (128). The upper end portion (125) and base (128) are joined to the outer perimeter wall (124) to define an interior compartment or chamber (130) for holding a beverage or food item as described further below.

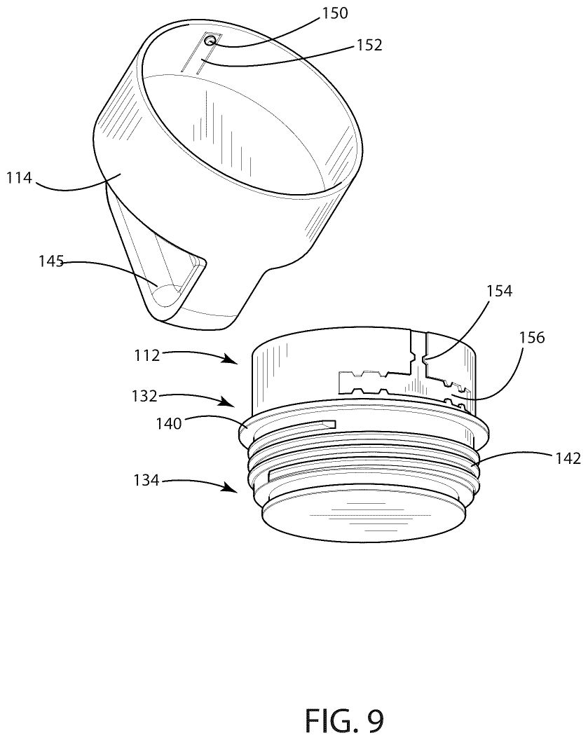

The inner container (112) is removably coupled to the main container (110). As shown in FIG. 9, in the inner container (112), the outer perimeter wall (124) has a top section (132) and lower section (134). A projecting collar (140) is disposed between the top and bottom sections (132, 134). The top section (132) has an outer periphery that contains slotted channels (152, 154). As described further below, the slotted channels (152, 154) engage a locking detent pin (150) in the interior of the cover (114) when the cover (114) is fastened to the inner container (112) as described further below.

The bottom section (134) of the inner container (112) also has an outer periphery that is threaded (142). These external threads (142) are complementary to the internal threads (137) of the main container (110). The external threads (142) of the bottom section (134) engage the internal threads (137) of the main container (110) when the inner container (112) is fastened to the main container (110). The intermediate projecting collar (140) is positioned between the top and bottom sections (132, 134).

In the embodiment shown in FIGS. 6-10, the interior portion of the cover (114) includes a spring-biased detent pin (150) extending from tab (152). The locking pin (150) is complementary to and fits in the slotted channels (154, 156) located in the top section (132) of the inner container (112). When the cover (114) is placed on the inner container (112), the locking pin (150) slides downwardly into the vertical-extending notched slot (154). When a person places the cover (114) on the inner container (112) and turns the cover (114), the locking pin (150) slides into the horizontally-extending notched slot (156). As the person rotates the cover (114) and the locking pin (150) registers with the horizontally-extending slot, he/she may hear a “click,”“click”and feel a tactile sensation as the cover (114) is being locked in place.

The vertically-extending and horizontally-extending channels are preferably notched and joined together to form an inverted T-shaped channel structure as shown in FIGS. 8 and 9. The cover (114) preferably includes an upper handle (145) having an inverted U-shape. The user can easily grasp the handle (145) with their left or right hand and turn the cover (114). In this manner, the cover (114) is locked with the inner container (112). The locking pin (150) registers and falls into alignment with the notches of the slotted channels (154, 156). Once the locking pin (150) is registered in line with the slotted channel (156), the cover (114) is locked to the inner container (112).

To release the locking mechanism, a person can press downwardly on the cover (114) and turn the cover so that the locking pin (150) is released. As discussed above, the user can easily grasp the handle (145) with their left or right hand and apply downward pressure to the cover. This action of exerting pressure on and rotating the cover (114) causes the locking pin (150) to move freely. As the person rotates the cover (114), he/she may feel tactile feedback that the cover (114) is being unlocked. The locking pin (150) can slide upwardly along the vertical slot (154). In this way, the cover (114) becomes unlocked and can thus be removed. The user can grasp the unlocked cover (114) and pull it off the inner container (112) easily.

When the cover (114) fastened to the inner container (112), any food and beverage items stored within the inner container (12) are prevented from spilling out. As discussed above, the cover (114) preferably includes an upper handle (145) having an inverted U-shape. The user can easily grasp the handle (145) with their left or right hand and hold the multi-compartment container assembly (106). The upper handle (145) is ergonomically designed so the user can comfortably and efficiently insert their fingers through the opening, while placing their thumb on the top surface of (147) to hold the multi-compartment container assembly (106) securely.

The present invention provides a unique food and beverage container assembly having multiple compartments that can be easily detached from each other. In one preferred embodiment, the container includes a main container (first compartment) for storing a first food or beverage item; and a second (inner) container (second compartment) for storing a second food or beverage item. The first and second compartments can be filled with various food and beverage items. Then, the first and second compartments can be easily attached to each other. In the present invention, the main container can contain a beverage such as, for example, water, energy drink, juice, milk, and the like, The inner container can include a food item such as, for example, trail mix, fruit, granola, and the like. The container assembly of the present invention is ideal for people participating in outdoor activities. For example, an athlete or backpack hiker can use the inner container to store a drink powder composition, for example, an energy drink powder; and use the main compartment for storing water. When a user needs to hydrate, he/she can detach the container assembly easily so that the first and second compartments are accessible. Then, the user can add the powder to the water and formulate an energy drink.

It should be understood the terms, “first”, “second”, “top”, “bottom”, “upper”, “lower”, “upwardly”, “downwardly”, “horizontal”, “vertical”, and the like are arbitrary terms used to refer to one position of an element based on one perspective and should not be construed as limiting the scope of the invention.

It also should be understood that the assemblies, constructions, materials, and the like described and illustrated herein represent only some embodiments of the invention. It is appreciated by those skilled in the art that various changes and additions can be made to the assemblies, constructions, materials, and the like herein without departing from the spirit and scope of this invention. It is intended that all such embodiments be covered by the appended claims.

I claim:

1. A multi-compartment container assembly for food and beverage items, the assembly comprising:
a) a main container having an outer perimeter wall; an upper end portion; and a bottom base, wherein the upper end portion and bottom base are joined to the outer perimeter wall to define a first interior compartment, and the upper end portion has internal threads;
b) an inner container removably fastened to the main container, the inner container having an outer perimeter wall; an upper end portion; and a bottom base, wherein the upper end portion and bottom base are joined to the outer perimeter wall to define a second interior compartment; the outer perimeter wall having a top section and lower section with a projecting collar disposed between the top and bottom sections; the top and bottom sections having external threads, the external threads of the bottom section engaging the internal threads of the main container; and
c) a cover removably fastened to the inner container; the cover having an internal cavity with upper and lower end portions, the lower end portion having internal threads, wherein the internal threads engage the external threads of the top section of the inner container.

2. The multi-compartment container assembly of claim 1, wherein the upper end portion of the main container has a peripheral rim having internal threads.

3. The multi-compartment container assembly of claim 1, wherein the upper end portion of the inner container has a peripheral rim.

4. The multi-compartment container assembly of claim 1, wherein the cover comprises an upper handle having an inverted U-shaped structure.

5. The multi-compartment container assembly of claim 1, wherein the main container is made from a material selected from the group consisting of metal and plastics.

6. The multi-compartment container assembly of claim 1, wherein the main container has a cylindrical shape.

7. The multi-compartment container assembly of claim 1, wherein the main container contains a beverage item, and the inner container contains a food item.

8. A multi-compartment container assembly for food and beverage items, the assembly comprising:
a) a main container having an outer perimeter wall; an upper end portion; and a bottom base, wherein the upper end portion and bottom base are joined to the outer perimeter wall to define a first interior compartment, and the upper end portion has internal threads;
b) an inner container removably fastened to the main container, the inner container having an outer perimeter wall; an upper end portion; and a bottom base, wherein the upper end portion and bottom base are joined to the outer perimeter wall to define a second interior compartment; the outer perimeter wall having a top section and lower section with a projecting collar disposed between the top and bottom sections; the top section having a slotted channel and the bottom section having external threads, the external threads of the bottom section engaging the internal threads of the main container; and
c) a cover removably fastened to the inner container; the cover having an internal cavity with upper and lower end portions, the lower end portion having a locking pin that engages a slotted channel in the top section of the inner container.

9. The multi-compartment container assembly of claim 8, wherein top section of the inner container contains a horizontally-extending channel and vertically-extending channel.

10. The multi-compartment container assembly of claim 9, wherein the horizontally-extending and vertically-extending channels are joined to form an inverted T-shaped channel structure.

11. The multi-compartment container assembly of claim 8, wherein the upper end portion of the main container has a peripheral rim having internal threads.

12. The multi-compartment container assembly of claim 8, wherein the upper end portion of the inner container has a peripheral rim.

13. The multi-compartment container assembly of claim 8, wherein the cover comprises an upper handle having an inverted U-shaped structure.

14. The multi-compartment container assembly of claim 8, wherein the main container is made from a material selected from the group consisting of metal and plastics.

15. The multi-compartment container assembly of claim 8, wherein the main container has a cylindrical shape.

16. The multi-compartment container assembly of claim 8, wherein the main container contains a beverage item, and the inner container contains a food item.
